(19) United States
(12) Patent Application Publication
(10) Pub. No.: US 2025/0052937 A1
(43) Pub. Date: Feb. 13, 2025

(54) LIQUID CRYSTAL OPTICAL ELEMENT AND DISPLAY DEVICE

(71) Applicants: Japan Display Inc., Tokyo (JP); OSAKA UNIVERSITY, Suita-shi (JP)

(72) Inventors: Koichi IGETA, Tokyo (JP); Junji KOBASHI, Tokyo (JP); Yasushi TOMIOKA, Tokyo (JP); Shinichiro OKA, Tokyo (JP); Hiroyuki YOSHIDA, Suita-shi (JP)

(73) Assignees: Japan Display Inc., Tokyo (JP); OSAKA UNIVERSITY, Suita-shi (JP)

(21) Appl. No.: 18/795,401

(22) Filed: Aug. 6, 2024

(30) Foreign Application Priority Data
Aug. 10, 2023 (JP) 2023-131150

(51) Int. Cl. G02B 5/30; C09K 19/30; C09K 19/36; C09K 19/50

(52) U.S. Cl. CPC G02B 5/3016; C09K 19/3098; C09K 19/36; C09K 19/50; C09K 2219/03

(57) ABSTRACT

According to one embodiment, a liquid crystal optical element includes a transparent substrate, and a liquid crystal layer which faces the transparent substrate and has a cholesteric liquid crystal and an additive exhibiting liquid crystallinity. Refractive anisotropy of the additive is less than refractive anisotropy of the liquid crystal layer.

### CROSS-REFERENCE TO RELATED APPLICATIONS

This application is based upon and claims the benefit of priority from Japanese Patent Application No. 2023-131150, filed Aug. 10, 2023, the entire contents of which are incorporated herein by reference.

### FIELD

Embodiments described herein relate generally to a liquid crystal optical element and a display device.

### BACKGROUND

For example, a liquid crystal polarization grating using a liquid crystal material is suggested. In this liquid crystal polarization grating, to realize the desired optical performance, various parameters such as a grating period, the refractive anisotropy Δn of a liquid crystal layer (the difference between refractive index ne for extraordinary light and refractive index no for ordinary light in a liquid crystal layer) and the thickness d of the liquid crystal layer need to be adjusted.

### BRIEF DESCRIPTION OF THE DRAWINGS

FIG. 1 is a cross-sectional view schematically showing a liquid crystal optical element 100 according to an embodiment.

FIG. 2 is a diagram for explaining an example of cholesteric liquid crystals CL contained in a liquid crystal layer 3.

FIG. 3 is a diagram for explaining another example of cholesteric liquid crystals CL contained in the liquid crystal layer 3.

FIG. 4 is a plan view schematically showing the liquid crystal optical element 100.

FIG. 5 is a diagram showing material examples which can be applied as an additive 4 in the embodiment.

FIG. 6 is a diagram showing material examples which can be applied as the additive 4 in the embodiment.

FIG. 7 is a diagram showing material examples which can be applied as the additive 4 in the embodiment.

FIG. 8 is a diagram showing material examples which can be applied as the additive 4 in the embodiment.

FIG. 9 is a diagram for explaining the manufacturing method of the liquid crystal optical element 100 according to the embodiment.

FIG. 10 is a diagram for explaining the manufacturing method of the liquid crystal optical element 100 according to the embodiment.

FIG. 11 is a diagram for explaining the manufacturing method of the liquid crystal optical element 100 according to the embodiment.

FIG. 12 is a diagram for explaining a state in which the additive 4 permeates the liquid crystal layer 3.

FIG. 13 is a diagram showing a configuration example of a display device 200.

FIG. 14 is a diagram for explaining a state in which display light DL is reflected.

### DETAILED DESCRIPTION

Embodiments described herein aim to provide a liquid crystal optical element and a display device in which the reflection range can be restricted.

In general, according to one embodiment, a liquid crystal optical element comprises a transparent substrate, and a liquid crystal layer which faces the transparent substrate and has a cholesteric liquid crystal and an additive exhibiting liquid crystallinity. Refractive anisotropy of the additive is less than refractive anisotropy of the liquid crystal layer.

According to another embodiment, a liquid crystal optical element comprises a transparent substrate, and a liquid crystal layer which faces the transparent substrate and has a cholesteric liquid crystal and an additive exhibiting liquid crystallinity. Refractive anisotropy of the additive is less than refractive anisotropy of the cholesteric liquid crystal.

According to yet another embodiment, a display device comprises a transparent substrate having a first main surface and a second main surface which faces the first main surface, a display module which faces the first main surface in a first area of the transparent substrate and is configured to emit display light, a first liquid crystal layer which faces the second main surface in the first area and has a first cholesteric liquid crystal, a second liquid crystal layer which overlaps the first liquid crystal layer and has a second cholesteric liquid crystal, and a third liquid crystal layer which overlaps the second liquid crystal layer and has a third cholesteric liquid crystal. Each of the first liquid crystal layer, the second liquid crystal layer and the third liquid crystal layer has an additive exhibiting liquid crystallinity. The first cholesteric liquid crystal, the second cholesteric liquid crystal and the third cholesteric liquid crystal have helical pitches which are different from each other. Refractive anisotropy of the additive is less than refractive anisotropy of each of the first liquid crystal layer, the second liquid crystal layer and the third liquid crystal layer.

According to yet another embodiment, a display device comprise a transparent substrate having a first main surface and a second main surface which faces the first main surface, a display module which faces the first main surface in a first area of the transparent substrate and is configured to emit display light, a first liquid crystal layer which faces the second main surface in the first area and has a first cholesteric liquid crystal, a second liquid crystal layer which overlaps the first liquid crystal layer and has a second cholesteric liquid crystal, and a third liquid crystal layer which overlaps the second liquid crystal layer and has a third cholesteric liquid crystal. Each of the first liquid crystal layer, the second liquid crystal layer and the third liquid crystal layer has an additive exhibiting liquid crystallinity. The first cholesteric liquid crystal, the second cholesteric liquid crystal and the third cholesteric liquid crystal have helical pitches which are different from each other. Refractive anisotropy of the additive is less than refractive anisotropy of each of the first cholesteric liquid crystal, the second cholesteric liquid crystal and the third cholesteric liquid crystal.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the drawings, in order to facilitate understanding, an X-axis, a Y-axis and a Z-axis orthogonal to each other are shown depending on the need. A direction parallel to the Z-axis is referred to as a Z-direction or a first direction A1. A direction parallel to the Y-axis is referred to as a Y-direction or a second direction A2. A direction parallel to the X-axis is referred to as an X-direction or a third direction A3. The plane defined by the X-axis and the Y-axis is referred to as an X-Y plane. The plane defined by the X-axis and the Z-axis is referred to as an X-Z plane. The plane defined by the Y-axis and the Z-axis is referred to as a Y-Z plane.

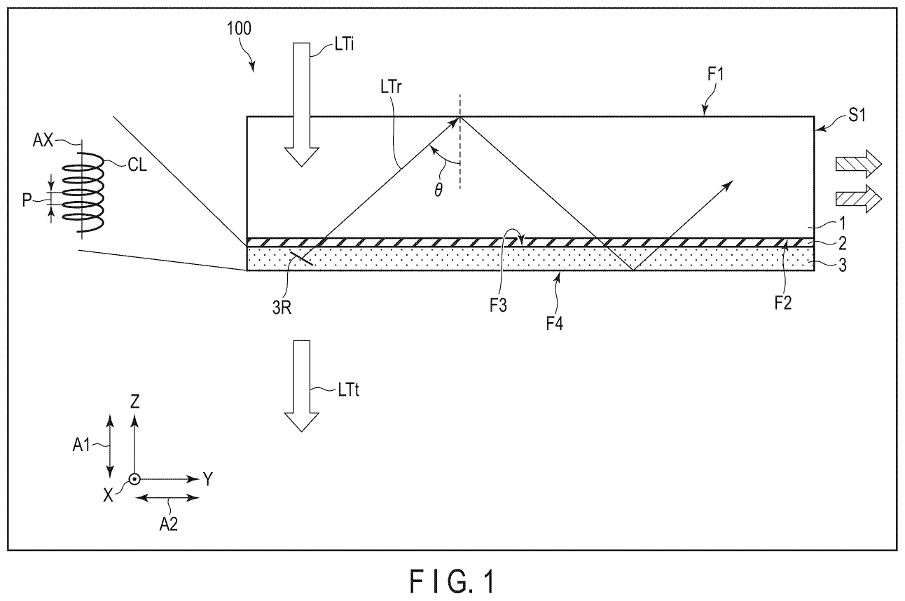

FIG. 1 is a cross-sectional view schematically showing a liquid crystal optical element 100 according to an embodiment.

The liquid crystal optical element 100 comprises a transparent substrate 1, an alignment film 2 and a liquid crystal layer 3.

The transparent substrate 1 consists of, for example, a transparent glass plate or a transparent synthetic resin plate. The transparent substrate 1 may consist of, for example, a transparent synthetic resin plate having flexibility. The transparent substrate 1 could have an arbitrary shape. For example, the transparent substrate 1 may be curved.

In this specification, the term “light” includes visible light and invisible light. For example, the wavelength of the lower limit of the visible light range is greater than or equal to 350 nm and less than or equal to 400 nm. The wavelength of the upper limit of the visible light range is greater than or equal to 700 nm and less than or equal to 830 nm. Visible light includes the first component (blue component) of a first wavelength range (for example, 400 nm to 500 nm), the second component (green component) of a second wavelength range (for example, 500 nm to 600 nm), and the third component (red component) of a third wavelength range (for example, 600 nm to 700 nm). Invisible light includes ultraviolet light having a wavelength range in which the wavelength is shorter than the first wavelength range, and infrared light having a wavelength range in which the wavelength is longer than the third wavelength range.

In this specification, the term “transparent” should preferably mean colorless and transparent. However, the term “transparent” may mean semitransparent, or colored and transparent.

The transparent substrate 1 is shaped like a flat plate parallel to an X-Y plane and has a first main surface (outer surface) F1, a second main surface (inner surface) F2 and a side surface S1. The first main surface F1 and the second main surface F2 are surfaces substantially parallel to an X-Y plane and face each other in a first direction A1. The side surface S1 is a surface extending in the first direction A1. In the example shown in FIG. 1, the side surface S1 is a surface substantially parallel to an X-Z plane. The side surface S1 includes a surface substantially parallel to a Y-Z plane.

The alignment film 2 is provided on the second main surface F2. The alignment film 2 is a horizontal alignment film having an alignment restriction force parallel to an X-Y plane. The alignment film 2 is, for example, an optical alignment film to which alignment treatment can be applied by light irradiation. However, the alignment film 2 may be either an alignment film to which alignment treatment is applied by rubbing or an alignment film having microscopic asperities. In place of the alignment film 2, an adhesive layer which causes the liquid crystal layer 3 to adhere to the transparent substrate 1 may be provided.

The liquid crystal layer 3 overlaps the alignment film 2 in the first direction A1. In other words, the alignment film 2 is located between the transparent substrate 1 and the liquid crystal layer 3 and is in contact with the transparent substrate 1 and the liquid crystal layer 3.

The liquid crystal layer 3 has a third main surface (inner surface) F3 and a fourth main surface (outer surface) 4F. The third main surface F3 and the fourth main surface F4 are surfaces substantially parallel to an X-Y plane and face each other in the first direction A1. The third surface F3 is in contact with the alignment film 2. The fourth main surface F4 is in contact with, for example, an air layer. However, the fourth main surface F4 may be covered with a transparent protective layer.

The liquid crystal layer 3 has a cholesteric liquid crystal CL which twists in a first twist direction as schematically shown in the enlarged view. The cholesteric liquid crystal CL has a helical axis AX substantially parallel to the first direction A1 and has helical pitch P parallel to the first direction A1. Helical pitch P indicates one period of the helix (in other words, the layer thickness parallel to the helical axis AX and required for a 360-degree rotation of the liquid crystal molecule).

The liquid crystal layer 3 has a reflective surface 3R. The reflective surface 3R reflects, of the incident light on the liquid crystal layer 3, circularly polarized light in a selective reflection range determined based on helical pitch P of the cholesteric liquid crystals CL and refractive anisotropy Δn of the liquid crystal layer 3. For example, when the first twist direction is right-handed, right-handed circularly polarized light is reflected on the reflective surface 3R. When the first twist direction is left-handed, left-handed circularly polarized light is reflected on the reflective surface 3R. In this specification, reflection in the liquid crystal layer 3 is accompanied by diffraction inside the liquid crystal layer 3. In this specification, circularly polarized light may be strict circularly polarized light or may be circularly polarized light which approximates elliptically polarized light.

In the example shown in FIG. 1, the liquid crystal layer 3 is configured such that part of light LTi which enters the liquid crystal optical element 100 from the first main surface F1 side is reflected toward the transparent substrate 1. It should be noted that the liquid crystal layer 3 may be configured to reflect part of the light which enters the liquid crystal layer from the fourth main surface F4 side. A liquid crystal layer which contains another cholesteric liquid crystal may be stacked in the liquid crystal layer 3 shown in FIG. 1 in the liquid crystal optical element 100. Such a cholesteric liquid crystal is, for example, a cholesteric liquid crystal having a helical pitch which is different from helical pitch P or a cholesteric liquid crystal which twists in a second twist direction opposite to the first twist direction.

Now, this specification explains the optical effect of the liquid crystal optical element 100 shown in FIG. 1.

Light LTi which enters the liquid crystal optical element 100 includes, for example, visible light, ultraviolet light and infrared light.

In the example shown in FIG. 1, in order to facilitate understanding, light LTi is assumed to enter the transparent substrate 1 substantially perpendicularly to the transparent substrate 1. It should be noted that the incident angle of light LTi with respect to the transparent substrate 1 is not particularly limited. For example, light LTi may enter the transparent substrate 1 at a plurality of incident angles different from each other.

Light LTi proceeds to the inside of the transparent substrate 1 from the first main surface F1, exits from the second main surface F2, passes through the alignment film 2 and enters the liquid crystal layer 3. The liquid crystal layer 3 reflects part of light LTi on the reflective surface 3R and transmits the other part of light LTi (in other words, light LTt). The reflected light LTr is circularly polarized light having wavelength A. For example, light LTr is first circularly polarized light having the wavelength range of visible light. Light LTt includes second circularly polarized light having the wavelength range of visible light in addition to infrared light and ultraviolet light. The second circularly polarized light is circularly polarized light which rotates in the opposite direction of the first circularly polarized light.

The entering angle θ of light LTr reflected on the liquid crystal layer 3 is set so as to satisfy optical waveguide conditions. Here, the entering angle θ corresponds to an angle greater than or equal to a critical angle which causes total reflection on the interface between the liquid crystal layer 3 and air. The entering angle θ indicates an angle with respect to the normal N of the transparent substrate 1.

When the transparent substrate 1, the alignment film 2 and the liquid crystal layer 3 have substantially the same refractive index, a stacked layer body of these elements could be an optical waveguide body as a single unit. In this case, light LTr is guided toward the side surface S1 while repeating reflection on the interface between the transparent substrate 1 and air and the interface between the liquid crystal layer 3 and air.

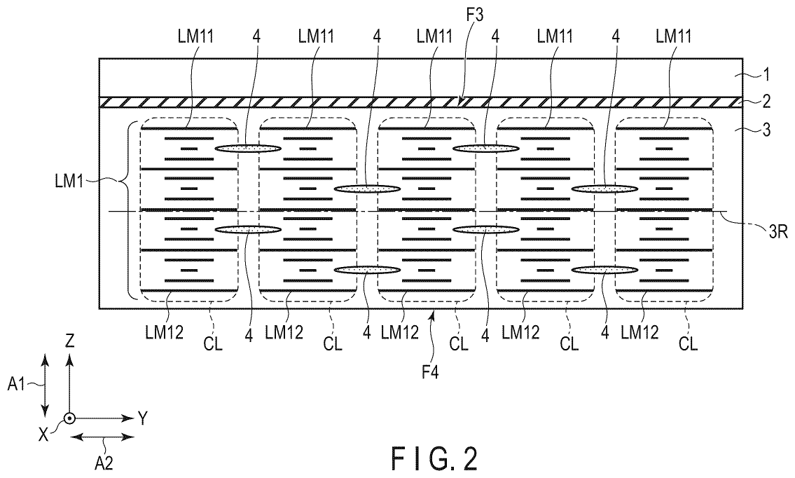

FIG. 2 is a diagram for explaining an example of cholesteric liquid crystals CL contained in the liquid crystal layer 3.

In FIG. 2, the liquid crystal layer 3 is enlarged in the first direction A1. In addition, to simplify the illustration, FIG. 2 shows one liquid crystal molecule LM1 among the liquid crystal molecules located in the same plane parallel to an X-Y plane as the liquid crystal molecules LM1 constituting each cholesteric liquid crystal CL. The alignment direction of each liquid crystal molecule LM1 shown in the figure corresponds to the average alignment direction of the liquid crystal molecules located in the same plane.

The liquid crystal layer 3 has cholesteric liquid crystals CL and an additive (guest liquid crystal) 4 exhibiting liquid crystallinity.

When one of the cholesteric liquid crystals CL surrounded by dotted lines is particularly looked at, the cholesteric liquid crystal CL consists of a plurality of liquid crystal molecules LM1 which are helically stacked in the first direction A1 while twisting. The liquid crystal molecules LM1 have a liquid crystal molecule LM11 on an end side of the cholesteric liquid crystal CL, and a liquid crystal molecule LM12 on the other end side of the cholesteric liquid crystal CL. The liquid crystal molecule LM11 is close to the third main surface F3 or the alignment film 2. The liquid crystal molecule LM12 is close to the fourth main surface F4.

In the liquid crystal layer 3 of the example shown in FIG. 2, the alignment directions of the cholesteric liquid crystals CL which are adjacent to each other in a second direction A2 are uniform. In other words, the alignment directions of the liquid crystal molecules LM11 which are adjacent to each other in the second direction A2 are substantially coincident with each other. In addition, the alignment directions of the liquid crystal molecules LM12 which are adjacent to each other in the second direction A2 are substantially coincident with each other.

The reflective surface 3R of the liquid crystal layer 3 is formed into a planar shape which extends parallel to an X-Y plane as shown by the one-dot chain line in the figure. Here, the reflective surface 3R corresponds to a surface in which the alignment directions of the liquid crystal molecules LM1 are uniform, or a surface (an equiphase wave surface) in which the spacial phase is uniform.

This liquid crystal layer 3 is cured in a state where the alignment directions of the liquid crystal molecules LM1 are fixed. In other words, an electric field does not control the alignment directions of the liquid crystal molecules LM1. For this reason, the liquid crystal optical element 100 does not comprise an electrode for forming an electric field in the liquid crystal layer 3.

The additive 4 substantially uniformly permeates the liquid crystal layer 3. The additive 4 is aligned in a manner similar to that of the cholesteric liquid crystals CL. This additive 4 has refractive anisotropy Δn4. Refractive anisotropy Δn4 is less than refractive anisotropy Δn3 of the cholesteric liquid crystals CL (Δn4<Δn3). Thus, refractive anisotropy Δn of the liquid crystal layer 3 decreases in accordance with the amount of the additive 4 added to the liquid crystal layer 3. Refractive anisotropy Δn does not exceed refractive anisotropy Δ4. In other words, refractive anisotropy Δn4 is less than refractive anisotropy Δn (Δn4<Δn).

It should be noted that refractive anisotropy Δn4 of the additive 4 may be zero. In other words, the additive 4 may be an isotropic material.

In general, in the liquid crystal layer 3 having cholesteric liquid crystals CL, the selective reflection range Δλ for the light which underwent perpendicular incidence is shown by the following formula (1) based on helical pitch P of the cholesteric liquid crystals CL and refractive anisotropy Δn of the liquid crystal layer 3 (the difference between refractive index ne for extraordinary light and refractive index no for ordinary light).

$$Δ λ = Δ n * P \qquad ( 1 )$$

The specific wavelength range of the selective reflection range Δλ is a range from (no*P) to (ne*P).

The center wavelength λm of the selective reflection range Δλ is shown by the following formula (2) based on helical pitch P of the cholesteric liquid crystals CL and the average refractive index nav (=(ne+no)/2) of the liquid crystal layer 3.

$$λ m = nav * P \qquad ( 2 )$$

For example, the center wavelength λm is a wavelength in the range of visible light of 350 nm to 700 nm.

Based on the above formula (1), for a request to restrict the selective reflection range Δλ so as to be small, refractive anisotropy Δ needs to be reduced, or helical pitch P needs to be reduced. However, as shown by the above formula (2), helical pitch P also affects the center wavelength λm. Therefore, the reduction in refractive anisotropy Δn is effective in order to shrink the selective reflection range Δλ while preventing the center wavelength λm from shifting to the short wavelength side.

In the embodiment, the liquid crystal layer 3 has the additive 4 in addition to cholesteric liquid crystals CL. Refractive anisotropy Δn4 of the additive 4 is less than refractive anisotropy Δn3 of cholesteric liquid crystals CL. Therefore, refractive anisotropy Δn of the liquid crystal layer 3 can be reduced compared with a case where the liquid crystal layer 3 does not have the additive 4. In this manner, the selective reflection range Δλ in the liquid crystal layer 3 can be restricted so as to be small.

In addition, the transmittance of the liquid crystal optical element 100 is improved by restricting the selective reflection range Δλ in the liquid crystal layer 3.

Further, even in a case where it is difficult to select a material for obtaining the desired refractive anisotropy Δn as the material for forming cholesteric liquid crystals CL, the desired refractive anisotropy Δn can be easily realized by adjusting the additive amount the additive 4.

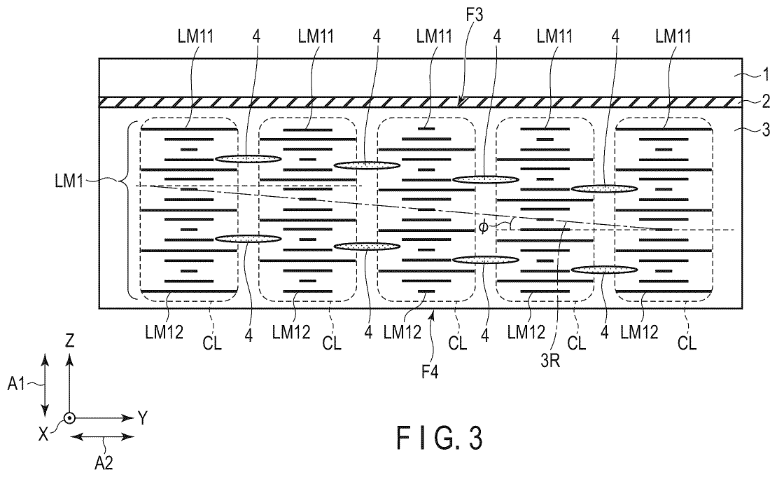

FIG. 3 is a diagram for explaining another example of cholesteric liquid crystals CL contained in the liquid crystal layer 3.

The example shown in FIG. 3 is different from that shown in FIG. 2 in respect that the alignment directions of a plurality of cholesteric liquid crystals CL which are adjacent to each other in the second direction A2 are different from each other. Further, the spacial phases of the cholesteric liquid crystals CL which are adjacent to each other in the second direction A2 are different from each other. The alignment directions of a plurality of liquid crystal molecules LM11 continuously change in the second direction A2. The alignment directions of a plurality of liquid crystal molecules LM12 also continuously change in the second direction A2. These alignment directions are described later.

The reflective surface 3R of the liquid crystal layer 3 inclines with respect to an X-Y plane as shown by the one-dot chain line in the figure. The angle φ between the reflective surface 3R and an X-Y plane is an acute angle.

It should be noted that the shape of the reflective surface 3R is not limited to the planar shapes shown in FIG. 2 and FIG. 3, and may be a curved shape such as a concave shape or a convex shape, and thus, is not particularly limited. Part of the reflective surface 3R may be uneven. The inclination angle φ of the reflective surfaces 3R may not be uniform. A plurality of reflective surfaces 3R may not be regularly aligned. The reflective surface 3R may be configured to have an arbitrary shape based on the distribution of the spacial phases of cholesteric liquid crystals CL.

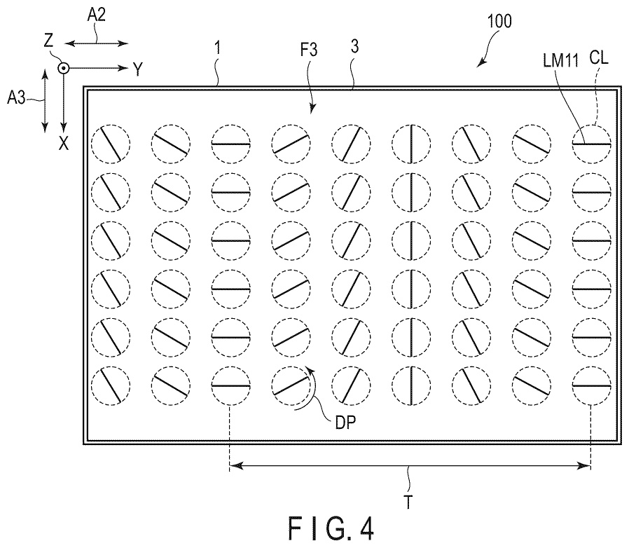

FIG. 4 is a plan view schematically showing the liquid crystal optical element 100.

FIG. 4 shows an example of the spacial phases of cholesteric liquid crystals CL. Here, the spacial phases are shown as the alignment directions of the liquid crystal molecules LM11 located near the third main surface F3 among the liquid crystal molecules LM1 contained in cholesteric liquid crystals CL.

Regarding the cholesteric liquid crystals CL arranged in the second direction A2, the alignment directions of the liquid crystal molecules LM11 are different from each other. In other words, the spacial phases of the cholesteric liquid crystals CL differ in the second direction A2.

To the contrary, regarding the cholesteric liquid crystals CL arranged in a third direction A3, the alignment directions of the liquid crystal molecules LM11 are substantially coincident with each other. In other words, the spacial phases of the cholesteric liquid crystals CL are substantially coincident with each other in the third direction A3.

In particular, regarding the cholesteric liquid crystals CL arranged in the second direction A2, the alignment direction varies with each liquid crystal molecule LM11 by a certain degree. In other words, the alignment direction linearly varies with the liquid crystal molecules LM11 arranged in the second direction A2. Thus, the spacial phase linearly varies in the second direction A2 with the cholesteric liquid crystals CL arranged in the second direction A2. As a result, the reflective surface 3R which inclines with respect to an X-Y plane is formed as in the case of the liquid crystal layer 3 shown in FIG. 3. Here, the phrase “linearly vary” means that, for example, the amount of variation in the alignment directions of the liquid crystal molecules LM11 is shown by a linear function. Here, the alignment direction of each liquid crystal molecule LM11 corresponds to the long axis direction of the liquid crystal molecule LM11 in an X-Y plane. The alignment direction of each liquid crystal molecule LM11 can be controlled by the alignment treatment which has been applied to the alignment film 2.

Here, as shown in FIG. 4, the interval between two liquid crystal molecules LM11 when the alignment directions of the liquid crystal molecules LM11 vary by 180 degrees in the second direction A2 in a plane is defined as period T. In FIG. 4, DP indicates the twist direction of each liquid crystal molecule LM11. The inclination angle φ of the reflective surface 3R shown in FIG. 3 is arbitrarily set based on period T and helical pitch P. Period T is, for example, 350 nm to 700 nm.

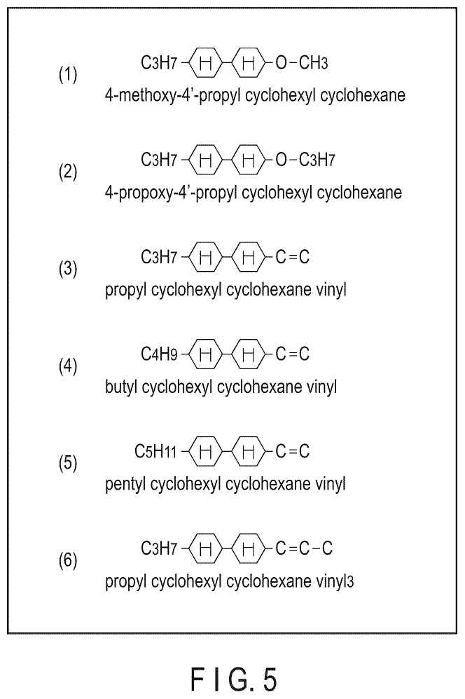

Here, material examples which can be applied as the additive 4 described above are explained with reference to FIG. 5 to FIG. 8.

Material examples (1) to (2) shown in FIG. 5 are examples of nematic liquid crystal materials, and alkoxycyclohexylcyclohexane-based materials. When the long axis of each of these nematic liquid crystal materials is parallel to the Y-axis in the liquid crystal layer 3, refractive index ny parallel to the Y-axis is greater than refractive index nx parallel to the X-axis (ny>nx). Thus, nematic liquid crystal materials have refractive anisotropy Δn in an X-Y plane.

Material examples (3) to (6) shown in FIG. 5 are examples of nematic liquid crystal materials, and cyclohexylcyclohexanevinyl-based materials.

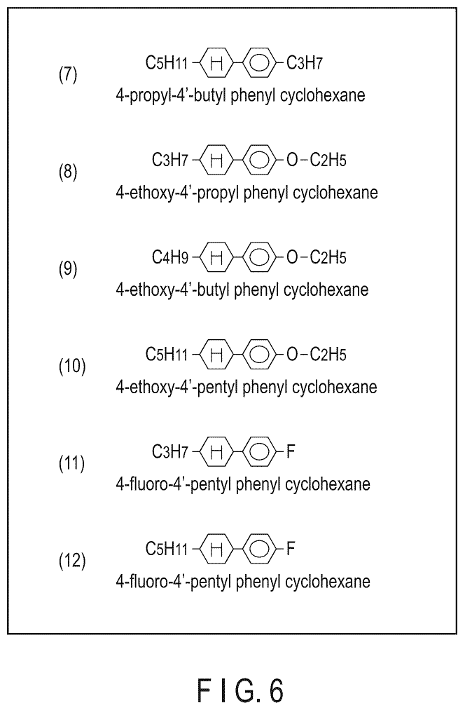

Material example (7) shown in FIG. 6 is an example of nematic liquid crystal materials, and an alkylphenylcyclohexane-based material.

Material examples (8) to (10) shown in FIG. 6 are examples of nematic liquid crystal materials, and alkoxyphenylcyclohexane-based materials.

Material examples (11) to (12) shown in FIG. 6 are examples of nematic liquid crystal materials, and fluorophenylcyclohexane-based materials.

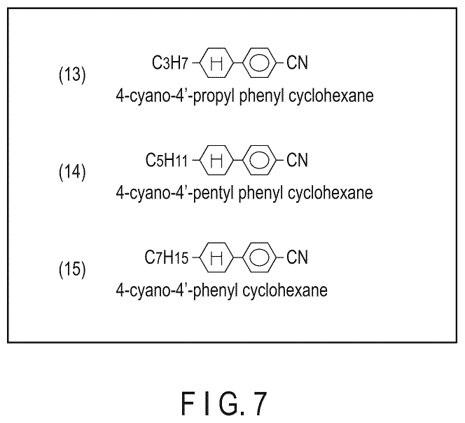

Material examples (13) to (15) shown in FIG. 7 are examples of nematic liquid crystal materials, and cyanophenylcyclohexane-based materials.

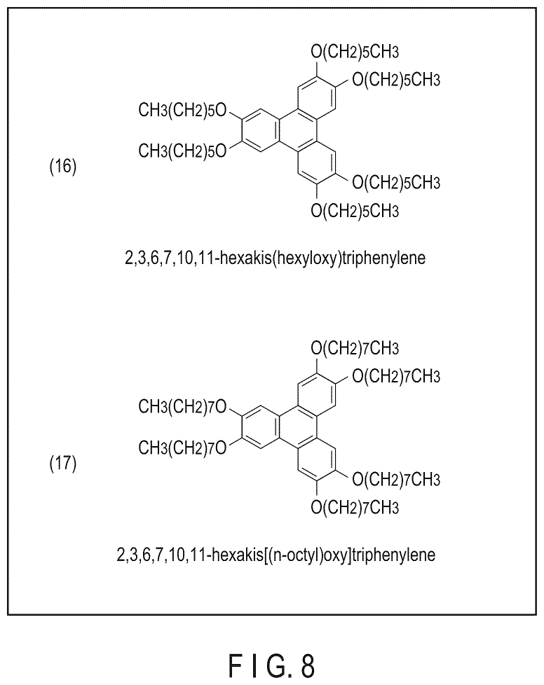

Material examples (16) to (17) shown in FIG. 8 are examples of discotic liquid crystal materials. When the short axis of each of these discotic liquid crystal materials is parallel to the Z-axis in the liquid crystal layer 3, refractive index nx parallel to the X-axis is substantially equal to refractive index ny parallel to the Y-axis (nx≈ny). Thus, discotic liquid crystal materials exhibit isotropy in an X-Y plane. Refractive anisotropy Δn of discotic liquid crystal materials is substantially zero.

Now, this specification explains the manufacturing method of the liquid crystal optical element 100.

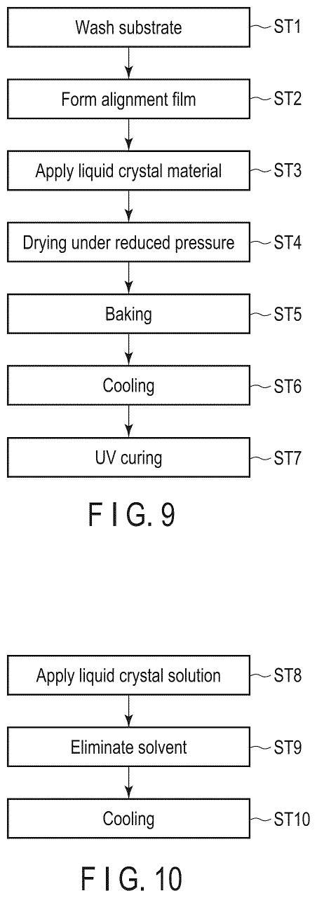

First, as shown in FIG. 9, the transparent substrate 1 is washed (step ST1).

Subsequently, the alignment film 2 is formed on the second main surface F2 of the transparent substrate 1 (step ST2). Predetermined alignment treatment is applied to the alignment film 2.

Subsequently, a liquid crystal material (a solution containing a monomer material for forming cholesteric liquid crystals) is applied to the upper side of the alignment film 2 (step ST3). Subsequently, the solvent is removed by decompressing the inside of the chamber, and the applied liquid crystal material is dried (step ST4). Further, the liquid crystal material is baked (step ST5). Through the baking, the liquid crystal molecules contained in the liquid crystal material are aligned in a predetermined direction based on the alignment treatment direction of the alignment film 2. Subsequently, the liquid crystal material is cooled to approximately a room temperature (step ST6). Subsequently, the liquid crystal material is cured by irradiating it with ultraviolet light (step ST7). By this process, the liquid crystal layer 3 having cholesteric liquid crystals CL is formed.

Subsequently, as shown in FIG. 10, a liquid crystal solution in which the additive 4 described above is dissolved in a solvent is prepared. For the solvent, an organic solvent such as hexane, cyclohexane, cyclohexanone, heptane, toluene, anisole or propylene glycol monomethyl ether acetate (PGMEA) can be applied. The liquid crystal solution is applied to the liquid crystal layer 3 (step ST8). Here, the application includes immersion of the liquid crystal layer 3 in the liquid crystal solution and dropping of the liquid crystal solution to the liquid crystal layer 3. By this process, the additive 4 contained in the liquid crystal solution uniformly permeates the liquid crystal layer 3 together with the solvent. An excess of the applied liquid crystal solution is eliminated by using a spinner etc. An organic solvent for eliminating the liquid crystal solution may be used depending on the need.

Subsequently, the solvent which permeated the liquid crystal layer 3 is eliminated by heating the transparent substrate 1, and the liquid crystal layer 3 is dried (step ST9). Subsequently, the transparent substrate 1 is cooled to approximately a room temperature (step ST10).

The additive amount of the additive 4 to the liquid crystal layer 3 can be adjusted by the number of times for performing the steps ST8 to ST10 described above. Thus, when the additive amount should be increased, the steps ST8 to ST10 described above should be repeated a plurality of times. By this process, the liquid crystal optical element 100 having the desired reflective performance is manufactured.

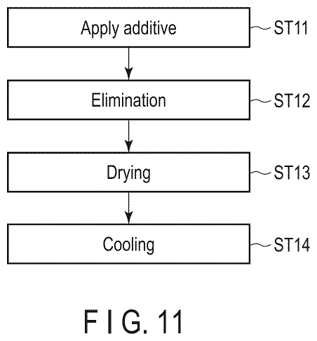

In place of the process shown in FIG. 10, the process shown in FIG. 11 may be applied. Now, this specification explains the process shown in FIG. 11.

First, a liquid additive 4 is prepared. The additive 4 in which the melting point is relatively low is liquefied by heating without using a solvent. The additive 4 is applied to the liquid crystal layer 3 (step ST11). Here, the application includes immersion of the liquid crystal layer 3 in the additive 4 and dropping of the additive 4 to the liquid crystal layer 3. By this process, the additive 4 uniformly permeates the liquid crystal layer 3.

Subsequently, an excess of the additive 4 is eliminated by using a spinner etc., (step SP12). It should be noted that an organic solvent for eliminating an excess of the additive 4 may be used depending on the need.

Subsequently, the liquid crystal layer 3 is dried by heating the transparent substrate 1 (step ST13).

Subsequently, the transparent substrate 1 is cooled to approximately a room temperature (step ST14).

The additive amount of the additive 4 to the liquid crystal layer 3 can be adjusted by the number of times for performing the steps ST11 to ST14 described above. Thus, when the additive amount should be increased, the steps ST11 to ST14 described above should be repeated a plurality of times. By this process, the liquid crystal optical element 100 having the desired reflective performance is manufactured.

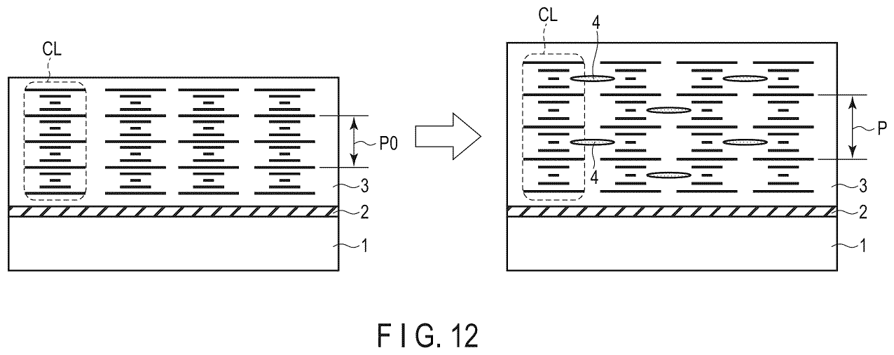

FIG. 12 is a diagram for explaining a state in which the additive 4 permeates the liquid crystal layer 3.

The left side of FIG. 12 shows the liquid crystal optical element 100 before the application of the liquid crystal solution. The right side of FIG. 12 shows the liquid crystal optical element 100 after the application of the liquid crystal solution. FIG. 12 schematically shows a state in which the additive 4 has been added.

Before the application of the liquid crystal solution, in the liquid crystal layer 3, cholesteric liquid crystals CL have helical pitch P0.

After the application of the liquid crystal solution, the liquid crystal layer 3 swells as the liquid crystal solution containing the additive 4 permeates the liquid crystal layer 3. Thus, helical pitch P of cholesteric liquid crystals CL is enlarged compared to helical pitch P0.

Helical pitch P obtained by the swelling of the liquid crystal layer 3 is set based on the center wavelength λm of the selective reflection range Δλ in which light should be reflected.

For example, when the center wavelength λm is 450 nm, and the average refractive index nav of the liquid crystal layer 3 is 1.6, helical pitch P is set so as to be approximately 280 nm.

When the center wavelength λm is 500 nm, and the average refractive index nav of the liquid crystal layer 3 is 1.6, helical pitch P is set so as to be approximately 310 nm.

When the center wavelength λm is 600 nm, and the average refractive index nav of the liquid crystal layer 3 is 1.6, helical pitch P is set so as to be approximately 380 nm.

Thus, in the liquid crystal layer 3 whose average refractive index nav is 1.6, when the wavelengths of visible light of 350 nm to 700 nm should be the center wavelength λm, helical pitch P is set so as to be greater than or equal to 200 nm and less than or equal to 450 nm.

At this time, for example, refractive anisotropy Δn of the liquid crystal layer 3 is greater than 0.1. For the additive 4, a material whose refractive anisotropy Δn4 is less than 0.1 can be used.

From another viewpoint, for example, refractive anisotropy Δn3 of cholesteric liquid crystals CL is greater than 0.1. For the additive 4, a material whose refractive anisotropy Δn4 is less than 0.1 can be used.

### Application Example

Now, this specification explains a display device 200 which can provide augmented reality as an application example of the liquid crystal optical element 100 of the embodiment.

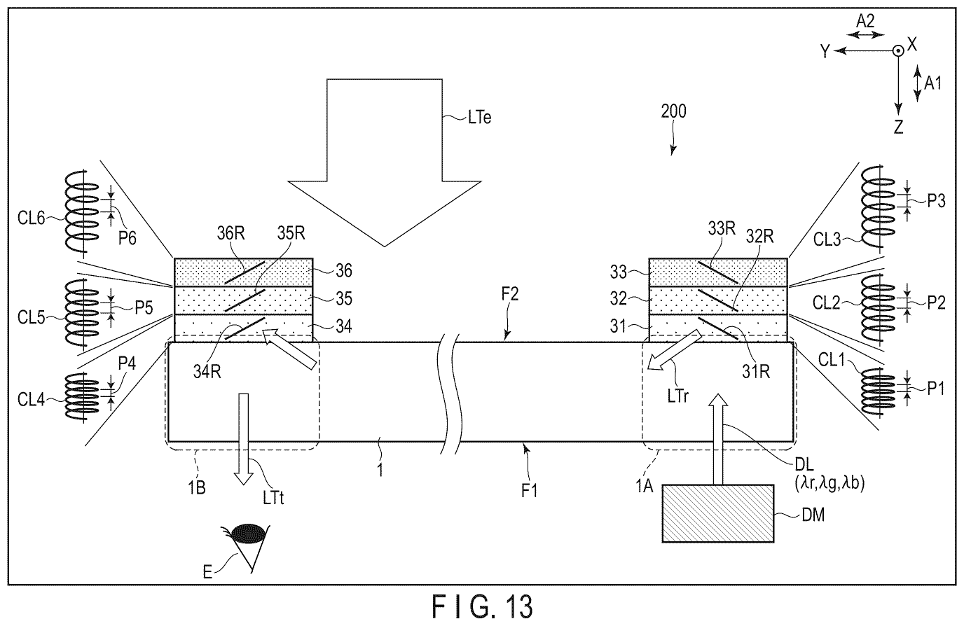

FIG. 13 is a diagram showing a configuration example of the display device 200.

The display device 200 comprises a transparent substrate 1, a display module DM, a first liquid crystal layer 31, a second liquid crystal layer 32, a third liquid crystal layer 33, a fourth liquid crystal layer 34, a fifth liquid crystal layer 35 and a sixth liquid crystal layer 36.

The transparent substrate 1 consists of a transparent glass plate or a transparent synthetic resin plate, and has a first main surface F1 and a second main surface F2. The transparent substrate 1 has a first area 1A on an end side of the transparent substrate 1, and a second area 1B on the other end side. In the example shown in the figure, the first area A1 and the second area 1B are arranged in the second direction A2 and are spaced apart from each other.

The display module DM faces the first main surface F1 in the first area 1A. The display module DM is configured to emit display light DL. The display module DM may be a combination of an illumination device including a light emitting element and a liquid crystal panel, or may be a display panel comprising a light emitting element such as an organic electroluminescent (EL) element, a micro LED or a mini LED. The display module DM comprises a red light emitting element, a green light emitting element and a blue light emitting element as light emitting elements.

The red light emitting element is configured to emit red light having center wavelength λr. The green light emitting element is configured to emit green light having center wavelength λg. The blue light emitting element is configured to emit blue light having center wavelength λb. Thus, display light DL emitted from the display module DM has red light having center wavelength λr, green light having center wavelength λg and blue light having center wavelength λb.

The first liquid crystal layer 31 faces the second main surface F2 in the first area 1A and has a first cholesteric liquid crystal CL1. The first liquid crystal layer 31 may be attached to the second main surface F2 or may be formed on an alignment film (not shown). The first cholesteric liquid crystal CL1 has helical pitch P1. The first liquid crystal layer 31 has a reflective surface 31R which inclines with respect to the second main surface F2.

The second liquid crystal layer 32 overlaps the first liquid crystal layer 31 and has a second cholesteric liquid crystal CL2. The second liquid crystal layer 32 is attached to the first liquid crystal layer 31. The second cholesteric liquid crystal CL2 has helical pitch P2. Helical pitch P2 is greater than helical pitch P1 (P2>P1). The second liquid crystal layer 32 has a reflective surface 32R which inclines with respect to the second main surface F2.

The third liquid crystal layer 33 overlaps the second liquid crystal layer 32 and has a third cholesteric liquid crystal CL3. The third liquid crystal layer 33 is attached to the second liquid crystal layer 32. The third cholesteric liquid crystal CL3 has helical pitch P3. Helical pitch P3 is greater than helical pitch P2 (P3>P2). The third liquid crystal layer 33 has a reflective surface 33R which inclines with respect to the second main surface F2.

All of the reflective surface 31R, the reflective surface 32R and the reflective surface 33R incline in the same manner. In the example shown in the figure, the interval parallel to the first direction A1 between each of the reflective surface 31R, the reflective surface 32R and the reflective surface 33R and the second main surface F2 gradually increases in a direction from the first area 1A to the second area 1B.

In the example shown in the figure, all of the first cholesteric liquid crystal CL1, the second cholesteric liquid crystal CL2 and the third cholesteric liquid crystal CL3 twist in the same direction. However, one of them may twist in the opposite direction.

Further, the stacking order of the first liquid crystal layer 31, the second liquid crystal layer 32 and the third liquid crystal layer 33 is not limited to the example shown in the figure.

The fourth liquid crystal layer 34 faces the second main surface F2 in the second area 1B and has a fourth cholesteric liquid crystal CL4. The fourth liquid crystal layer 34 may be attached to the second main surface F2 or may be formed on an alignment film (not shown). The fourth liquid crystal layer 34 has a reflective surface 34R which inclines with respect to the second main surface F2.

The fourth cholesteric liquid crystal CL4 has helical pitch P4. Helical pitch P4 is equal to helical pitch P1 (P4=P1). Helical pitch P1 and helical pitch P4 are set based on center wavelength λb. The first cholesteric liquid crystal CL1 and the fourth cholesteric liquid crystal CL4 twist in the same direction.

The fifth liquid crystal layer 35 overlaps the fourth liquid crystal layer 34 and has a fifth cholesteric liquid crystal CL5. The fifth liquid crystal layer 35 is attached to the fourth liquid crystal layer 34. The fifth liquid crystal layer 35 has a reflective surface 35R which inclines with respect to the second main surface F2.

The fifth cholesteric liquid crystal CL5 has helical pitch P5. Helical pitch P5 is greater than helical pitch P4 (P5>P4) and equal to helical pitch P2 (P5=P2). Helical pitch P2 and helical pitch P5 are set based on center wavelength λg. The second cholesteric liquid crystal CL2 and the fifth cholesteric liquid crystal CL5 twist in the same direction.

The sixth liquid crystal layer 36 overlaps the fifth liquid crystal layer 35 and has a sixth cholesteric liquid crystal CL6. The sixth liquid crystal layer 36 is attached to the fifth liquid crystal layer 35. The sixth liquid crystal layer 36 has a reflective surface 36R which inclines with respect to the second main surface F2.

The sixth cholesteric liquid crystal CL6 has helical pitch P6. Helical pitch P6 is greater than helical pitch P5 (P6>P5) and equal to helical pitch P3 (P6=P3). Helical pitch P3 and helical pitch P6 are set based on center wavelength λr. The third cholesteric liquid crystal CL3 and the sixth cholesteric liquid crystal CL6 twist in the same direction.

All of the reflective surface 34R, the reflective surface 35R and the reflective surface 36R incline in the same manner. In the example shown in the figure, the interval parallel to the first direction A1 between each of the reflective surface 34R, the reflective surface 35R and the reflective surface 36R and the second main surface F2 gradually decreases in a direction from the first area 1A to the second area 1B.

In the example shown in the figure, all of the fourth cholesteric liquid crystal CL4, the fifth cholesteric liquid crystal CL5 and the sixth cholesteric liquid crystal CL6 twist in the same direction. However, one of them may twist in the opposite direction.

Further, the stacking order of the fourth liquid crystal layer 34, the fifth liquid crystal layer 35 and the sixth liquid crystal layer 36 is not limited to the example shown in the figure.

The second main surface F2 is in contact with an air layer between the first area 1A and the second area 1B or between the first liquid crystal layer 31 and the fourth liquid crystal layer 34. The first main surface F1 is in contact with an air layer in the entire area including the first area 1A and the second area 1B.

Here, the first liquid crystal layer 31, the second liquid crystal layer 32, the third liquid crystal layer 33, the fourth liquid crystal layer 34, the fifth liquid crystal layer 35 and the sixth liquid crystal layer 36 have the additive 4 as explained with reference to FIG. 3. The refractive anisotropy of the additive 4 is less than that of each of the liquid crystal layers. The refractive anisotropy of the additive 4 is less than that of each of the cholesteric liquid crystals.

Now, this specification explains the optical effect of the display device 200 shown in FIG. 13.

The display module DM emits display light DL including red light having center wavelength λr, green light having center wavelength λg and blue light having center wavelength λb toward the transparent substrate 1. Display light DL proceeds to the inside of the transparent substrate 1 from the first main surface F1, exits from the second main surface F2 and enters the first liquid crystal layer 31, the second liquid crystal layer 32 and the third liquid crystal layer 33. Display light DL is partly reflected on the reflective surface 31R of the first liquid crystal layer 31, the reflective surface 32R of the second liquid crystal layer 32 and the reflective surface 33R of the third liquid crystal layer 33. The reflected light LTr enters the transparent substrate 1 again and is guided toward the second area 1B while repeating reflection on the interfaces between the transparent substrate 1 and the air layers between the first area 1A and the second area 1B.

In the second area 1B, light LTr exits from the second main surface F2 and enters the fourth liquid crystal layer 34, the fifth liquid crystal layer 35 and the sixth liquid crystal layer 36. Light LTr is partly reflected on the reflective surface 34R of the fourth liquid crystal layer 34, the reflective surface 35R of the fifth liquid crystal layer 35 and the reflective surface 36R of the sixth liquid crystal layer 36. The reflected light LTr passes through the transparent substrate 1. Light LTt which passed through the transparent substrate 1 is guided to the eyes E of the user.

Each of the first liquid crystal layer 31, the second liquid crystal layer 32, the third liquid crystal layer 33, the fourth liquid crystal layer 34, the fifth liquid crystal layer 35 and the sixth liquid crystal layer 36 reflects only light in a specific selective reflection range in external light LTe and transmits light in the other ranges. The transparent substrate 1 transmits most components of external light LTe. Thus, the user can visually recognize an image displayed in the display module DM while visually recognizing the circumference environment of the display device 200.

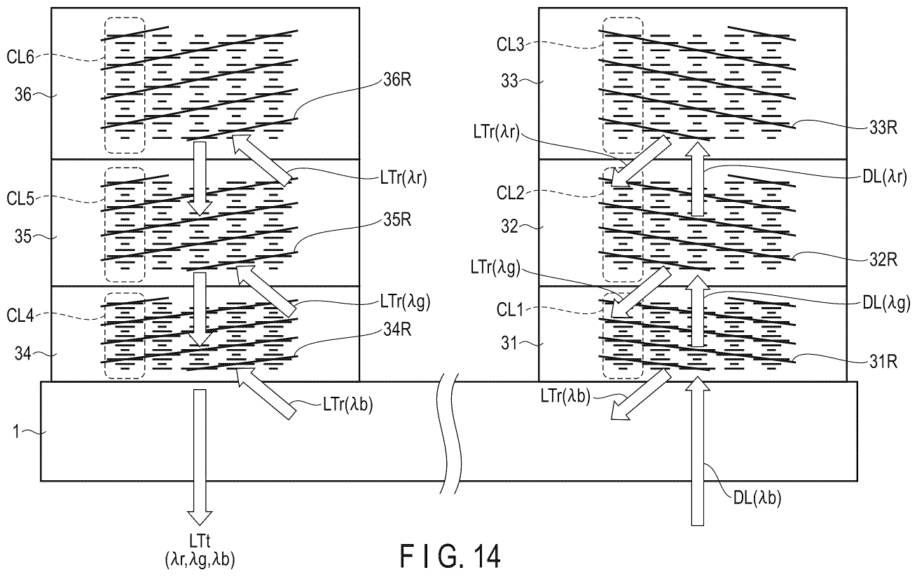

FIG. 14 is a diagram for explaining a state in which display light DL is reflected.

In the first liquid crystal layer 31, the reflective surface 31R is formed as the alignment directions of the adjacent first cholesteric liquid crystals CL1 linearly change. On the reflective surface 31R, of display light DL, the circularly polarized light of blue light having center wavelength λb is reflected.

In the second liquid crystal layer 32, the reflective surface 32R is formed as the alignment directions of the adjacent second cholesteric liquid crystals CL2 linearly change. On the reflective surface 32R, of display light DL, the circularly polarized light of green light having center wavelength λg is reflected.

In the third liquid crystal layer 33, the reflective surface 33R is formed as the alignment directions of the adjacent third cholesteric liquid crystals CL3 linearly change. On the reflective surface 33R, of display light DL, the circularly polarized light of red light having center wavelength λr is reflected.

In the fourth liquid crystal layer 34, the reflective surface 34R is formed as the alignment directions of the adjacent fourth cholesteric liquid crystals CL4 linearly change. On the reflective surface 34R, blue light LTr reflected on the reflective surface 31R and having center wavelength λb is reflected.

In the fifth liquid crystal layer 35, the reflective surface 35R is formed as the alignment directions of the adjacent fifth cholesteric liquid crystals CL5 linearly change. On the reflective surface 35R, green light LTr reflected on the reflective surface 32R and having center wavelength λg is reflected.

In the sixth liquid crystal layer 36, the reflective surface 36R is formed as the alignment directions of the adjacent sixth cholesteric liquid crystals CL6 linearly change. On the reflective surface 36R, red light LTr reflected on the reflective surface 33R and having center wavelength λr is reflected.

Light LTt which passed through the transparent substrate 1 has blue light LTr having center wavelength λb, green light LTr having center wavelength λg and red light LTr having center wavelength λr.

This display device 200 can provide the user with augmented reality.

As explained above, the embodiment can provide a liquid crystal optical element and a display device in which the reflection range can be restricted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal optical element comprising:
a transparent substrate; and
a liquid crystal layer which faces the transparent substrate and has a cholesteric liquid crystal and an additive exhibiting liquid crystallinity, wherein
refractive anisotropy of the additive is less than refractive anisotropy of the liquid crystal layer.

2. A liquid crystal optical element comprising:
a transparent substrate; and
a liquid crystal layer which faces the transparent substrate and has a cholesteric liquid crystal and an additive exhibiting liquid crystallinity, wherein
refractive anisotropy of the additive is less than refractive anisotropy of the cholesteric liquid crystal.

3. The liquid crystal optical element of claim 1, wherein
the additive is formed of a nematic liquid crystal material or a discotic liquid crystal material.

4. The liquid crystal optical element of claim 3, wherein
the additive is formed of an alkoxycyclohexylcyclohexane-based material, a cyclohexylcyclohexanevinyl-based material, an alkylphenylcyclohexane-based material, an alkoxyphenylcyclohexane-based material, a fluorophenylcyclohexane-based material or a cyanophenylcyclohexane-based material.

5. The liquid crystal optical element of claim 2, wherein
the additive is formed of a nematic liquid crystal material or a discotic liquid crystal material.

6. The liquid crystal optical element of claim 5, wherein
the additive is formed of an alkoxycyclohexylcyclohexane-based material, a cyclohexylcyclohexanevinyl-based material, an alkylphenylcyclohexane-based material, an alkoxyphenylcyclohexane-based material, a fluorophenylcyclohexane-based material or a cyanophenylcyclohexane-based material.

7. The liquid crystal optical element of claim 1, wherein
a helical pitch of the cholesteric liquid crystal is greater than or equal to 200 nm and less than or equal to 450 nm.

8. The liquid crystal optical element of claim 2, wherein
a helical pitch of the cholesteric liquid crystal is greater than or equal to 200 nm and less than or equal to 450 nm.

9. The liquid crystal optical element of claim 1, wherein
refractive anisotropy of the liquid crystal layer is greater than 0.1, and
refractive anisotropy of the additive is less than 0.1.

10. The liquid crystal optical element of claim 2, wherein
refractive anisotropy of the cholesteric liquid crystal is greater than 0.1, and
refractive anisotropy of the additive is less than 0.1.

11. A display device comprising:
a transparent substrate having a first main surface and a second main surface which faces the first main surface;
a display module which faces the first main surface in a first area of the transparent substrate and is configured to emit display light;
a first liquid crystal layer which faces the second main surface in the first area and has a first cholesteric liquid crystal;
a second liquid crystal layer which overlaps the first liquid crystal layer and has a second cholesteric liquid crystal; and
a third liquid crystal layer which overlaps the second liquid crystal layer and has a third cholesteric liquid crystal, wherein
each of the first liquid crystal layer, the second liquid crystal layer and the third liquid crystal layer has an additive exhibiting liquid crystallinity,
the first cholesteric liquid crystal, the second cholesteric liquid crystal and the third cholesteric liquid crystal have helical pitches which are different from each other, and
refractive anisotropy of the additive is less than refractive anisotropy of each of the first liquid crystal layer, the second liquid crystal layer and the third liquid crystal layer.

12. A display device comprising:
a transparent substrate having a first main surface and a second main surface which faces the first main surface;
a display module which faces the first main surface in a first area of the transparent substrate and is configured to emit display light;
a first liquid crystal layer which faces the second main surface in the first area and has a first cholesteric liquid crystal;
a second liquid crystal layer which overlaps the first liquid crystal layer and has a second cholesteric liquid crystal; and
a third liquid crystal layer which overlaps the second liquid crystal layer and has a third cholesteric liquid crystal, wherein
each of the first liquid crystal layer, the second liquid crystal layer and the third liquid crystal layer has an additive exhibiting liquid crystallinity,
the first cholesteric liquid crystal, the second cholesteric liquid crystal and the third cholesteric liquid crystal have helical pitches which are different from each other, and
refractive anisotropy of the additive is less than refractive anisotropy of each of the first cholesteric liquid crystal, the second cholesteric liquid crystal and the third cholesteric liquid crystal.

13. The display device of claim 11, further comprising:
a fourth liquid crystal layer which faces the second main surface in a second area spaced apart from the first area in the transparent substrate and has a fourth cholesteric liquid crystal and the additive;
a fifth liquid crystal layer which overlaps the fourth liquid crystal layer and has a fifth cholesteric liquid crystal and the additive; and
a sixth liquid crystal layer which overlaps the fifth liquid crystal layer and has a sixth cholesteric liquid crystal and the additive, wherein
the first cholesteric liquid crystal and the fourth cholesteric liquid crystal have an equal helical pitch and twist in a same direction,
the second cholesteric liquid crystal and the fifth cholesteric liquid crystal have an equal helical pitch and twist in a same direction, and
the third cholesteric liquid crystal and the sixth cholesteric liquid crystal have an equal helical pitch and twist in a same direction.

14. The display device of claim 12, further comprising:
a fourth liquid crystal layer which faces the second main surface in a second area spaced apart from the first area in the transparent substrate and has a fourth cholesteric liquid crystal and the additive;
a fifth liquid crystal layer which overlaps the fourth liquid crystal layer and has a fifth cholesteric liquid crystal and the additive; and
a sixth liquid crystal layer which overlaps the fifth liquid crystal layer and has a sixth cholesteric liquid crystal and the additive, wherein
the first cholesteric liquid crystal and the fourth cholesteric liquid crystal have an equal helical pitch and twist in a same direction,
the second cholesteric liquid crystal and the fifth cholesteric liquid crystal have an equal helical pitch and twist in a same direction, and
the third cholesteric liquid crystal and the sixth cholesteric liquid crystal have an equal helical pitch and twist in a same direction.
